(19) United States
(12) Patent Application Publication
(10) Pub. No.: US 2013/0185401 A1
(43) Pub. Date: Jul. 18, 2013

(54) CONFIGURATION MANAGEMENT DEVICE, CONFIGURATION MANAGEMENT METHOD, AND CONFIGURATION MANAGEMENT PROGRAM

(71) Applicants: Yasuhiro Ajiro, Tokyo (JP); Kazuo Yanoo, Tokyo (JP)

(72) Inventors: Yasuhiro Ajiro, Tokyo (JP); Kazuo Yanoo, Tokyo (JP)

(73) Assignee: NEC CORPORATION, Tokyo (JP)

(21) Appl. No.: 13/825,763

(22) PCT Filed: Sep. 15, 2011
(86) PCT No.: PCT/JP2011/071750

§ 371 Date: Mar. 22, 2013

(30) Foreign Application Priority Data
Sep. 24, 2010 (JP) 2010-213410

(51) Int. Cl. H04L 12/24

(52) U.S. Cl. CPC H04L 41/0826
USPC 709/220

(57) ABSTRACT

[Problem] To provide a configuration management device which derives a combination of a plurality of types of devices having two indices where the total of a first index (P1) is equal to or greater than a specified value and the total of a second index (P2) becomes the minimum.

[Solution] A configuration management device comprises: a device storage means for storing a P1 and a P2 for each of a plurality (J) of types of the devices; a configuration update means for inputting a required value N and acquiring a minimum set (N, i) while increasing i to J, where, a) if a total of P2s of a new set which is acquired by replacing at least a part of a minimum set (N, i−1) with a device of i-th type, the minimum set (N, i) is the new set, and b) if the total of P2s of each new set is not smaller than the minimum total (N, i−1), the minimum set (N, i) is the minimum set (N, i−1); and an output means for outputting a minimum set (N, J).

### TECHNICAL FIELD

The present invention relates to a configuration management device, a configuration management method and a configuration management program which derive a combination of devices, and in particular relates to the configuration management device, the configuration management method and the configuration management program which derive a combination of the device which satisfies specified conditions.

### BACKGROUND ART

The patent document 1 disclosed a system proposing method and a system proposing device which output a configuration which satisfies a performance requirement and a price requirement within a range of a specified error as a configuration of a suggested target object. According to the document, a system configuration definition unit of the system proposing device receives elements of a target system for performance evaluation, connection relationship of the elements, behavior of applications, specifications and parameters of each resource, performance requirements, and price requirements. These elements can include such as a database management system, applications at a server side and applications at a client side. The connection relationship among the elements includes how these elements are connected through a network. The behavior of the applications includes such as number of process steps and number of issuances of DB (Database) search functions and DB update functions. The specifications and the parameters of each resource include such as number of CPUs (Central Processing Unit) and MIPS (Million Instructions Per Second) value of a computer, seek time of hard disks and setting parameters of database management system or the like. The performance of a system is a response time. The performance requirement is a value representing performance of a system whose configuration is output by the system proposing device, such as 5 seconds of the response time. The price requirement is a value representing price of a system whose configuration is output by the system proposing device, such 10 million yen.

The optimal configuration calculation unit of the system proposing device according to the document formulates configurations in which elements of above-mentioned performance evaluation targeted system, connection relationship of the elements, behavior of the applications and specifications and parameters of each resource are combined, and calculates a response time to each configuration by a performance simulator. In addition, the optimal configuration calculation unit calculates a total price of hardware and software of each formulated configuration. Based on the calculated response time and the total price of each configuration, the optimal configuration calculation unit outputs a configuration which satisfies performance requirements and price requirements within a specified error range. As the result, it can output a configuration which satisfies the performance requirement and the price requirement within a short time.

The patent document 2 disclosed a system configuration mechanism which extracts elements (i.e. components) which satisfy specified conditions, determines a system configuration and outputs the system configuration. These components includes such as CPUs, memories and hard disks. The conditions for extracting the components include system specifications such as clock speed and number of CPUs, memory capacity and hard disk capacity and user requirements such as budget and delivery date. The system configuration mechanism according to the document includes an extraction function and a determination function.

The extraction function extracts the components such as CPUs, memories and hard disks which satisfy system specifications from a components specification table. The determination function removes components which cannot be delivered before a time limit of delivery among user requirements, from components which the extraction function extracted. Further, the determination function removes components which cannot satisfy limitation of a budget when adopted. The system configuration mechanism outputs information on components which are not removed.

The patent document 3 disclosed a method of deriving a system configuration and an apparatus for deriving a system configuration which calculate a system configuration whose probability that a processing time of transaction exceeding a specified response time is less than or equal to a specified value and a price becomes lowest. The apparatus for deriving a system configuration according to the patent document 3 acquires the system configuration in which a performance function representing a function of performance satisfies a constraint condition and minimizes a price function as an objective function using Lagrange multiplier. The performance function and the price function are functions whose variables are system configuration data. The constraint condition means that a probability that the processing time of the transaction is equal to or more than a response time A is less than or equal to B, at the time of execution of target jobs of a performance guarantee. The system configuration parameters include S that is CPU performance, NCPU that is number of CPUs, M that is whole memory capacity, I that is I/O (i.e. Input/Output) processing speed and NJ that is number of allowable jobs for concurrent execution.

The configuration deriving device according to the patent document 3, while increasing number of CPU from 1 to the maximum number of CPUs that can be extended, repeats the following processes. First, the apparatus for deriving a system configuration according to the patent document 3 calculates an optimal system parameter (i.e. S, M and I) when NCPU (i.e. number of CPUs) is fixed using Lagrange multiplier. Then, the apparatus for deriving a system configuration according to the patent document 3 searches a smallest actual system parameter set which is closest of its distance from the optimal system parameter which is obtained by calculation, among price data.

The configuration deriving device according to the patent document 3 determines the parameter set (i.e. NCPU, S, M and I) of the system configuration in which the price is lowest, from the optimized system configuration in each number of CPUs derived by increasing number of CPU one by one from 1 to the maximum number of CPUs that can be extended. Then, the configuration deriving device according to the patent document 3 calculates NJ (i.e. number of allowable jobs for concurrent execution) for the calculated system variable (i.e. S, NCPU, M and I).

### PRIOR ART REFERENCE

### Patent Document

Patent document 1: Japanese Patent Application Laid-Open No. 2002-183416

Patent document 2: Japanese Patent Application Laid-Open No. 2002-020568

Patent document 3: Japanese Patent Application Laid-Open No. 2004-030292

### BRIEF SUMMARY OF THE INVENTION

### Problems to be Solved by the Invention

The system proposing device according to the patent document 1 formulates a plurality of configurations each of which is a combination of system elements, connection relationship among the elements, behavior of applications, usage of each resource, and designation of parameters. Then the system proposing device calculates the response time and the price of all formulated configurations, and outputs configurations thereof which satisfy the performance requirement and the price requirement within the range of a specified error.

Accordingly, according to the technology disclosed in the patent document 1, there was a problem that it cannot output the configuration whose price is lowest and which satisfies the performance equal to or more than a definite level.

The system configuration mechanism according to the patent document 2 extracts each type of component which satisfies a specified condition for each type of the component, and selects a combination of the components in which the total price of the components, where each one was selected from each type of extracted component, will be less than or equal to a specified value.

According to the technology disclosed in the patent document 2, there is a problem that, when combining a plurality of types of components having two kinds of indexes, among combinations in which components whose total value of one of the indexes is equal to or more than a specified value are included, it is not able to select a combination in which the total value of the other index is smallest.

The configuration deriving device according to the patent document 3 calculates the optimal system configuration parameters for each number of CPUs from 1 to the maximum number of CPUs that can be extended, and selected a system configuration parameter set in which the price is lowest among them.

According to the technology disclosed in the patent document 3, there was a problem that the performances of respective CPU are assumed to be identical.

The object of the present invention is to provide a configuration management device which derives, from a set of devices of plural types, each of which has two different indexes, a combination of the devices, which has, among combinations which satisfies a condition that the total of one indexes is equal to or more than a specified value, the smallest total of the other indexes.

### Means to Solve the Problems

A configuration management device, where a set is composed of i types of devices, each of the devices is associated with a P1 which is a value of a first index and a P2 which is a value of a second index for each of the types, and the set whose total of the P2s is smallest among the sets whose totals of the P1s are equal to or more than n is denoted as a minimum set (n, i), and a total of the P2s of the devices which belong to the minimum set (n, i) is denoted as a minimum total (n, i), comprises: a device storage means for storing the P1 and the P2 for each of a plurality (J) of types of the devices; a configuration update means for inputting a required value N and acquiring a minimum set (N, i) while increasing i to J, where, a) if a total of the P2s of a new set which is acquired by replacing at least a part of a minimum set (N, i−1) with a device of i-th type, the minimum set (N, i) is the new set, and b) if the total of the P2s of each new set is not smaller than the minimum total (N, i−1), the minimum set (N, i) is the minimum set (N, i−1); and an output means for outputting a minimum set (N, J).

A configuration management method, where a set is composed of i types of devices, each of the devices is associated with a P1 which is a value of a first index and a P2 which is a value of a second index for each of the types, and the set whose total of the P2s is smallest among the sets whose totals of the P1s are equal to or more than n is denoted as a minimum set (n, i), and a total of the P2s of the devices which belong to the minimum set (n, i) is denoted as a minimum total (n, i), comprises: storing the P1 and the P2 for each of a plurality (J) of types of the devices in a device storage means; inputting a required value N and acquiring a minimum set (N, i) while increasing i to J, where, a) if a total of the P2s of a new set which is acquired by replacing at least a part of a minimum set (N, i−1) with a device of i-th type, the minimum set (N, i) is the new set, and b) if the total of the P2s of each new set is not smaller than the minimum total (N, i−1), the minimum set (N, i) is the minimum set (N, i−1); and outputting a minimum set (N, J).

A non-transitory computer-readable medium stores a configuration management program which makes a computer execute, where a set is composed of i types of devices, each of the devices is associated with a P1 which is a value of a first index and a P2 which is a value of a second index for each of the types, and the set whose total of the P2s is smallest among the sets whose totals of the P1s are equal to or more than n is denoted as a minimum set (n, i), and a total of the P2s of the devices which belong to the minimum set (n, i) is denoted as a minimum total (n, i), as: a device storage means for storing the P1 and the P2 for each of a plurality (J) of types of the devices; a configuration update means for inputting a required value N and acquiring a minimum set (N, i) while increasing i to J, where, a) if a total of the P2s of a new set which is acquired by replacing at least a part of a minimum set (N, i−1) with a device of i-th type, the minimum set (N, i) is the new set, and b) if the total of the P2s of each new set is not smaller than the minimum total (N, i−1), the minimum set (N, i) is the minimum set (N, i−1); and an output means for outputting a minimum set (N, J).

### Effect of the Invention

The present invention has an effect that it is possible to derive, from a set of devices of plural types, each of which has two different indexes, a combination of the devices, which has, among combinations which satisfy a condition that the total of one indexes is equal to or more than a specified value, the smallest total of the other indexes.

### BRIEF DESCRIPTION OF THE DRAWINGS

FIG. 1 is a block diagram showing a configuration of a configuration management device 1 according to the first exemplary embodiment.

FIG. 2 is a flowchart showing an example of an operation in which the configuration management device 1 according to the first exemplary embodiment derives a minimum set.

FIG. 3 is the first example of device information.

FIG. 4 is an example of a minimum totals (n, 1) and a replacement device types (n, 1) which a configuration update unit 14 stores in a configuration storage unit 12.

FIG. 5 is an example of the minimum totals (n, 2) and the replacement device types (n, 2) which the configuration update unit 14 stores in the configuration storage unit 12.

FIG. 6 is an example of the minimum totals (n, 3) and the replacement device types (n, 3) which the configuration update unit 14 stores in the configuration storage unit 12.

FIG. 7 is a block diagram showing a configuration of a configuration management device 1A according to the second exemplary embodiment.

FIG. 8 is a flowchart showing an example of an operation in which the configuration management device 1A according to the second exemplary embodiment derives the minimum set.

FIG. 9 is the second example of model information. FIG. 10 is an example of the minimum totals (n, 1) and the replacement device types (n, 1) which a configuration update unit 14A stores in the configuration storage unit 12.

FIG. 11 is an example of the minimum totals (n, 2) and the replacement device types (n, 2) which the configuration update unit 14A stores in the configuration storage unit 12.

FIG. 12 is an example of the minimum totals (n, 3) and the replacement device types (n, 3) which the configuration update unit 14A stores in the configuration storage unit 12.

FIG. 13 is a flowchart showing an example of an operation in which the configuration management device 1 according to the first exemplary embodiment obtains indexes of a device.

FIG. 14 is a flowchart showing an example of an operation in which the configuration management device 1A according to the second exemplary embodiment obtains indexes of a device.

FIG. 15 is a block diagram showing a configuration of a configuration management device 1B according to the third exemplary embodiment.

### EXEMPLARY EMBODIMENT TO CARRY OUT THE INVENTION

Exemplary embodiments according to the present invention described below can be realized by hardware, a computer and software for controlling the computer, or a combination of these.

### First Exemplary Embodiment

Next, the followings are detailed explanations of the embodiment according to the present invention with reference to the drawings.

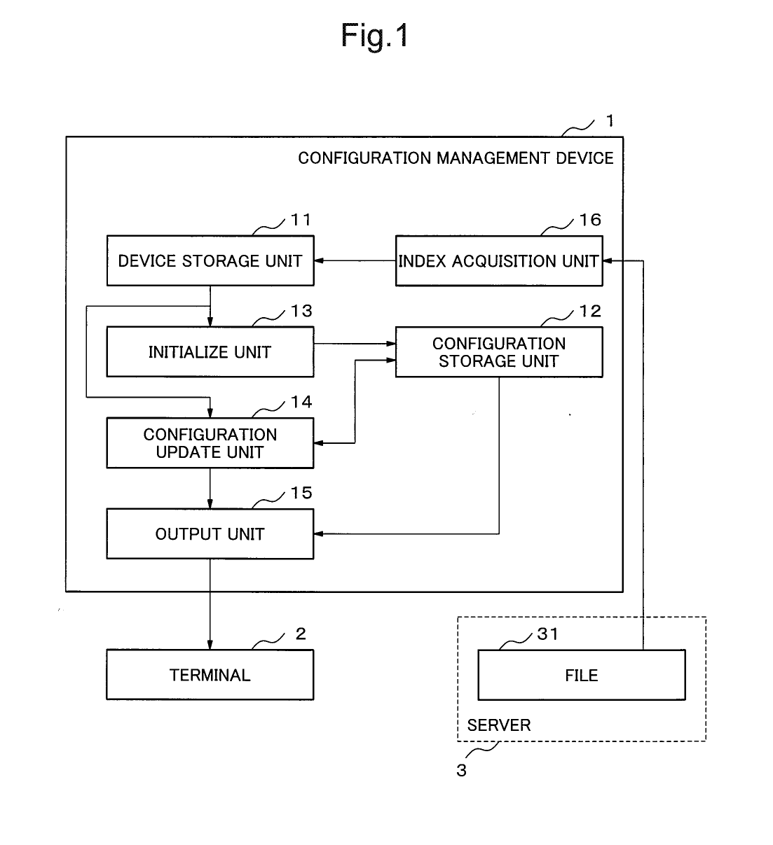

FIG. 1 is the block diagram showing a configuration of the configuration management device 1 according to the first exemplary embodiment of the present invention.

Referring to FIG. 1, the configuration management device 1 according to the exemplary embodiment includes a device storage unit 11, a configuration storage unit 12, an initialize unit 13, a configuration update unit 14, an output unit 15 and an index acquisition unit 16. In addition, a terminal 2 and a server 3 including a file 31 are connected with the configuration management device 1. Further, instead of the server 3, the configuration management device 1 can include the file 31.

The device storage unit 11 stores two indexes of each type among a plurality of types of devices, each of which has at least two different indexes. The device is, for example, a CPU, or a computing device such as a server. The first index among two indexes is, for example, an index representing performance of a device. The index representing performance is an index such as throughput, a MIPS value and a FLOPS (FLoating point number Operations Per Second) value. In addition, the first index can be an index representing reliability or availability or the like. The second index among two indexes is such as an index representing cost of a device. The index representing cost is an index, such as a price, power consumption, amount of exhaust heat, weight and installation space, which influences a configuration cost or an operation cost of a system. In addition, the second index can be a value such as number of components which composes a device. These two indexes corresponding to a plurality of devices are total values of the respective indexes of the devices.

The first index and the second index of each of the devices, which the device storage unit 11 stores, can be given in advance, or obtained by the index acquisition unit 16, which is described below.

The configuration storage unit 12 stores a minimum total, that is a total value of the second indexes of a minimum set, that is a set whose total of the second indexes is minimum among sets of the devices whose total of the first indexes in each of the sets is equal to or more than a specified value, that is a required value, and information representing a replacement device type, that is a type of the device last added to the minimum set, associating with the required value. The required value corresponding to the minimum total and the replacement device type, which the configuration storage unit 12 stores, is a series of integer numbers from 0 to N. That is, the configuration storage unit 12 stores the respective minimum total and the respective replacement device type associating with each integer from 0 to integer N. However, when there exists a common divisor of N and the first indexes, which the device storage unit 11 stores, of a plurality of types of the devices and the common divisor is larger than 1, values which are the first indexes of each device and N respectively divided by this common divisor are considered as new first indexes and a new N and can be stored as the minimum totals and the replacement device types.

In the following descriptions according to the exemplary embodiment, the minimum set (n, i) is a minimum set whose total of the first indexes is equal to or more than n among sets of devices which includes only the devices with a number representing a device type being less than or equal to i in numerical order. In addition, the minimum total (n, i) is a total of the second indexes of the devices included in the minimum set (n, i). The replacement device type (n, i) is information which represents a type of the device last added to the minimum set (n, i), such as a code, a symbol and character strings. The device of i-th type is such as a device which the device storage unit 11 stores in the i-th sequential order, or a device whose magnitude of the first index or the second index is the i-th largest or the i-th smallest. A method to determine sequential order of types of the devices is arbitrary.

The configuration storage unit 12 can store the minimum total, for example, as a plurality of array with length of N+1. In this case, the configuration storage unit 12 stores the minimum total (n, i), for example, as the n-th element of the i-th array. In addition the configuration storage unit 12 can store the minimum total, for example, as a two-dimensional array, in which the element in the i-th row and the n-th column is the minimum total (n, i). Similarly, the configuration storage unit 12 can store the replacement device type as a plurality of arrays with length of N+1. In this case, the configuration storage unit 12 stores the replacement device type (n, i), for example, as the n-th element of the i-th array. In addition, the configuration storage unit 12 can store the replacement device type, for example, as the two-dimensional array in which the element in the i-th row and the n-th column is the replacement device type (n, i).

Further, according to the exemplary embodiment, the configuration storage unit 12 can store the minimum total and the replacement device type as an array where the length is N+1 respectively. In this case, when the configuration update unit 14, which is described below, calculates the minimum total (n, i), the configuration storage unit 12 stores the minimum total (n, i) in the elements from the 0-th element to the (n−1)-th element of the array and the minimum total (n, i−1) in the elements from the n-th element to the N-th element of the array. Then, the configuration update unit 14 stores the calculated minimum total (n, i) in the n-th element of the array. The configuration storage unit 12 can also store the replacement device type in the same form as the above-mentioned minimum total.

The integer N is a required value which a total value of the first indexes of the set of the devices outputted by the configuration management device 1 has to exceed. The integer N is assigned to the configuration management device 1 in advance, or is inputted by a user or the like to the configuration management device 1, for example, via the terminal 2.

When the set includes only devices of the first device type, the initialize unit 13 derives the minimum total (n, 1) and the replacement device type (n, 1) for each integer n from 0 to N, which is for the total value of the first indexes.

For that purpose, the initialize unit 13 first reads out, device information of the first type of device from the device storage unit 11. The device information according to the exemplary embodiment is the first index and the second index. For example, the device information of the i-th type of device is the first index (i.e. P1(i)) and the second index (i.e. P2(i)). The device information which the initialize unit 13 reads out is the first index (i.e. P1(1)) and the second index (i.e. P2(1)) of the first device type. The initialize unit 13 calculates the minimum total (n, 1) based on the P1(1) and the P2(1), which are read out. Because the set includes only the devices of the first type, the minimum total (n, 1) is the smallest integer equal to or more than a value which equals to n divided by the first index of the first type of the devices. In addition, the replacement device type (n, 1) is information which represents the first type of the devices for all n.

When n equals 0, irrespective of the value of i, the minimum set (n, i) does not include a device. Accordingly, in this case, the minimum total (n, i) equals 0, and it is needless to calculate. In addition, because the minimum set (n, i) does not include devices, the device last added the device last added to the minimum set (n, i) does not exist.

In an example according to the exemplary embodiment, when n equals 0, the initialize unit 13 set the replacement device type (n, 1) to a value (e.g. 0 or Null value) representing that the device last added does not exist. In the following descriptions, information representing the type of one of the devices is denoted as an valid value, and a value representing that the last added device does not exist is denoted as a invalid value. According to the exemplary embodiment, Null value is the invalid value.

In addition, when n becomes less than 0 in the process of calculation, the minimum total (n, i) equals 0 and the replacement device type (n, i) is the invalid value, and it is needless to calculate, as is similar to the case that n equals 0. According to the exemplary embodiment, a configuration storage unit 13 does not store the minimum total (n, i) nor the replacement device type (n, i) for n if n is less than 0. When n is less than 0, the configuration update unit 14 does not read out the minimum total (n, i) nor the replacement device type (n, i) from the configuration storage unit 12. Then, it is preferable that the configuration update unit 14 considers the minimum total (n, i) as 0, and considers the replacement device type (n, i) as the invalid value. In addition, when n is less than 0, the configuration update unit 14 can read out the minimum total (n, i) and the replacement device type (n, i) in the case where n is 0, as the minimum total (n, i) and the replacement device type (n, i) in the case where n is less than 0, from the configuration storage unit 12.

The initialize unit 13 stores the minimum total (n, 1) and the replacement device type (n, 1) which are calculated in the configuration storage unit 12.

The configuration update unit 14 performs an updating process of the minimum total and the replacement device type as the following descriptions, while increasing i from 2 to J (where J is the number of types of the devices).

First, the configuration update unit 14 reads out the first index P1(i) and the second index P2(i) of the i-th type of the devices from the device storage unit 11.

Then, the configuration update unit 14 performs following processes, while increasing n from 1 to N. First, the configuration update unit 14 compares the minimum total (n, i−1) and the summation of the minimum total (n−P1(i), i) and P2(i) (i.e. minimum total (n−P1(i), i)+P2(i)). When n−P1(i) is smaller than 0, the configuration update unit 14 considers the minimum total (n−P1(i), i) as 0.

The minimum total (n, i−1) is a total of the second indexes in a set which includes only the devices which are of types whose number in numerical order is less than or equal to i−1, and the total of the second indexes of the set is the smallest among sets of the devices whose total of the first indexes in each of the sets is equal to or more than n. On the other hand, the summation of the minimum total (n−P1(i), i) and P2(i) is the total of the second indexes of the set which includes at least one device of i-th type and the total of the second indexes of the set is smallest among sets of the devices whose total of the first indexes in each of the sets is equal to or more than n. Accordingly, smaller one of the minimum total (n, i−1) and the summation of the minimum total (n−P1(i), i) and P2(i), which are read out similarly, is the minimum set (n, i).

When the summation of the minimum total (n−P1(i), i) and P2(i) is smaller than the minimum total (n, i−1), the configuration update unit 14 sets the minimum total (n, i) to the summation of the minimum total (n−P1(i), i) and P2(i). In this case, because the device last added to the minimum set is the device of the i-th type, the configuration update unit 14 sets information representing the i-th type as the replacement device type (n, i).

When the minimum total (n, i−1) is not larger than the summation of the minimum total (n−P1(i), i) and P2(i), the configuration update unit 14 sets the minimum total (n, i−1) to the minimum total (n, i). In addition, in this case, because the replacement device type (n, i) is the same as the replacement device type (n, i−1), the configuration update unit 14 sets the replacement device type (n, i−1) as the replacement device type (n, i).

The configuration update unit 14 stores the minimum total (n, i) and the replacement device type (n, i) in the configuration storage unit 12.

In the above described processes, when the summation of the minimum total (N−P1(i), i) and P2(i) is smaller than the minimum total (N, i−1), the configuration update unit 14 sets the set which is the sum of one device of the i-th type and the minimum set (N−P1(i), i) as the minimum set (N, i). In this case, the minimum set (N, i) is a set where at least a part of the minimum set (N, i−1) is replaced with one device of the i-th type.

The output unit 15 derives the minimum set (N, J) from each replacement device type which the configuration storage unit 12 stores, and outputs the minimum total (N, J) which is read out from the configuration storage unit 12 and the derived minimum set (N, J). A destination of the output unit 15 is, for example, the terminal 2.

The output unit 15 performs derivation of the minimum set (N, J), for example, as follows.

First, the output unit 15 sets an empty set as a set (i.e. solution set) for outputting as the minimum set (N, J). Because the device last added the device last added to the minimum set (N, J) is the replacement device type (N, J), the output unit 15 reads out the replacement device type (N, J) from the configuration storage unit 12 and adds the replacement device type (N, J) to the solution set. A set which is made by excluding a device of the replacement device type (N, J) from the minimum set (N, J), is the minimum set (N−P1(X), J), where the first index of the replacement device type (N, J) is denoted as P1(X).

Similarly, because the device last added the device last added to the minimum set (n, J) is the replacement device type (n, J), the output unit 15 reads out the replacement device type (n, J) from the configuration storage unit 12 and adds the replacement device type (n, J) to the solution set. A set which is made by excluding the replacement device type (n, J) from the minimum set (n, J) is the minimum set (n−P1(x), J), where the first index of the replacement device type (n, J) is denoted as P1(x).

As described above, the process, in which the device last added to the minimum set (n, J) is excluded from the minimum set (n, J) and is added to the solution set and the minimum set (n−P1(x), J), which is made by excluding the replacement device type (n, J) from the minimum set (n, J), is set to the minimum set from which the last added device is excluded next, is repeated until n becomes equal to or less than 0.

The minimum set (N, J) is the solution set when n becomes equal to or less than 0.

The index acquisition unit 16 extracts the first index and the second index of each device included in the file 31 which is stored in, for example, the server 3, and stores in the device storage unit 11. The server 3 can be the configuration management device 1 itself, or can be another device which is connected with network so that it is possible to communicate. For example, the file 31 includes such as one or more files which are included in one or more web pages, in which a vendor of each device is disclosing specifications of each device on the Internet, or a file which is included in a database including specification of each device.

For example, by an instruction of a user via an input unit or the like of the terminal 2 which is not illustrated, designating URI (Uniform Resource Identifier) or the like which identifies a web page or the like, the index acquisition unit 16 obtains the file 31. The index acquisition unit 16 extracts the first index and the second index of each device included in the file 31 using a character string such as “performance” and “price”, “power consumption” and “number of components” or the like as a key, and stores them in the device storage unit 11. In addition, by an instruction which designates a query or the like to a database via the input unit or the like of the terminal 2 which is not illustrated, the index acquisition unit 16 can obtain the first index and the second index from the database. The index acquisition unit 16 can extract information (e.g. CPU and clock speed or the like of the device) to get the index from the file 31 using a character string as a key, and obtain the first index and the second index based on the information which is extracted from the database in which the indexes are stored.

Then, it will describe operations of the configuration management device 1 according to the exemplary embodiment in detail with reference to the drawings.

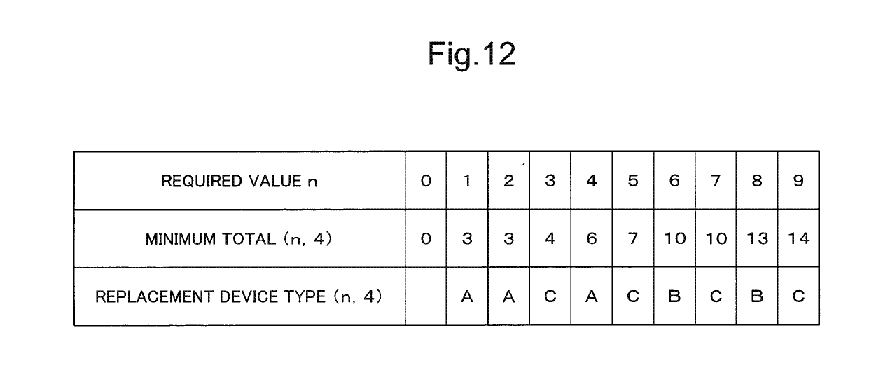

FIG. 13 is a flowchart showing an example of an operation in which the configuration management device 1 according to the exemplary embodiment obtains indexes of a device.

Referring to FIG. 13, first, the index acquisition unit 16 receives an instruction via the input unit or the like of the terminal 2 which is not illustrated, and obtains the file 31 which includes the first index and the second index for each type of the devices (Step S31).

Then, the index acquisition unit 16 extracts the first index and the second index for each type of the devices from the obtained file 31 (Step S32).

The index extraction unit 16 stores the extracted first index and the extracted second index of a type for each type of the devices and stores them in the device storage unit 11 associating with the type of the devices (Step S33).

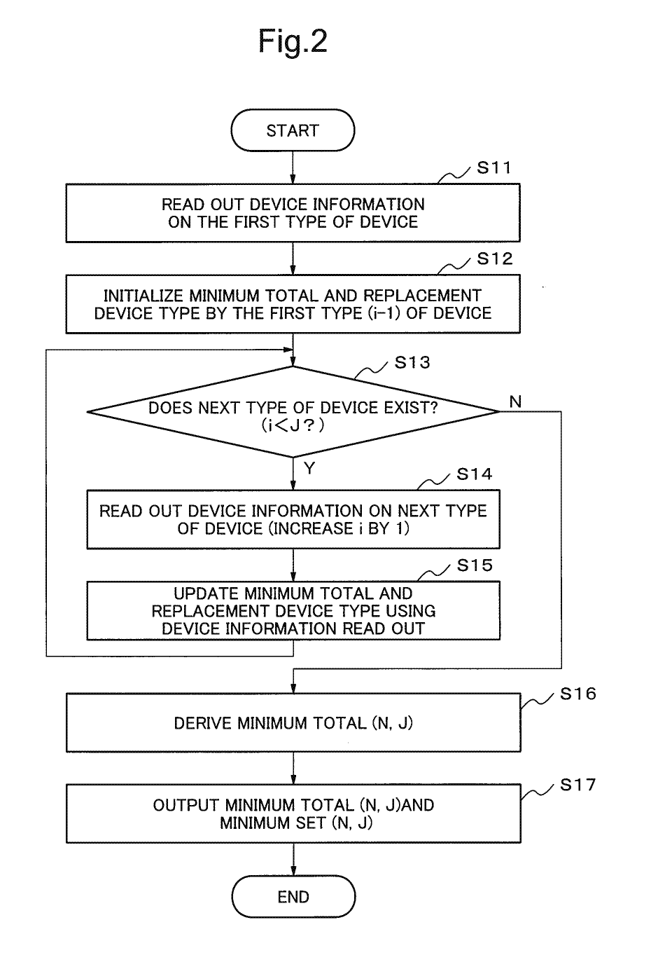

FIG. 2 is a flowchart showing an example of an operation in which the configuration management device 1 according to the first exemplary embodiment derives the minimum total and the minimum set.

Referring to FIG. 2, first, the initialize unit 13 reads out the device information on the first type of the devices from the device storage unit 11 (Step S11). As is described above, the device information on the first type of the devices according to the exemplary embodiment is the first index P(1) and the second index P2(1). In this case, i which represents an order of a type of the devices equals 1.

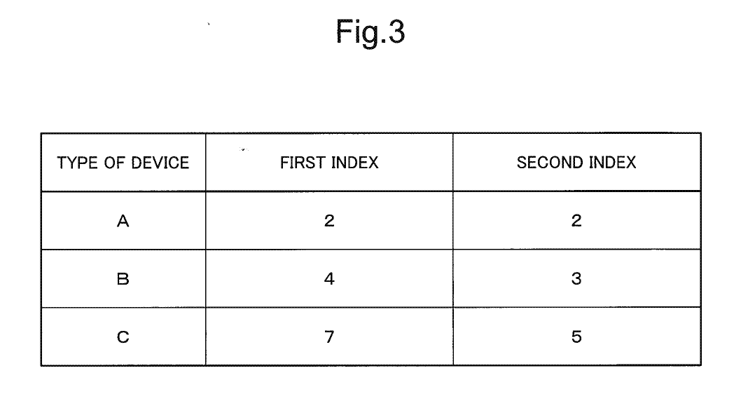

FIG. 3 is an example of the device information which the device storage unit 11 stores. FIG. 3 shows that, for example, the first index equals 2 and the second index equals 2 for the device of the device type A. In the following descriptions, a device of the first type is a device of device type A, a device of the second type is a device of device type B and a device of the third type is a device of device type C.

Then, the initialize unit 13 derives the minimum total (n, 1) and the replacement device type (n, 1) in which only the first type of device is taken into account for all n from 0 to N. The initialize unit 13 stores all of the derived minimum total (n, 1) and the derived replacement device type (n, 1) in the configuration storage unit 12 (Step S12).

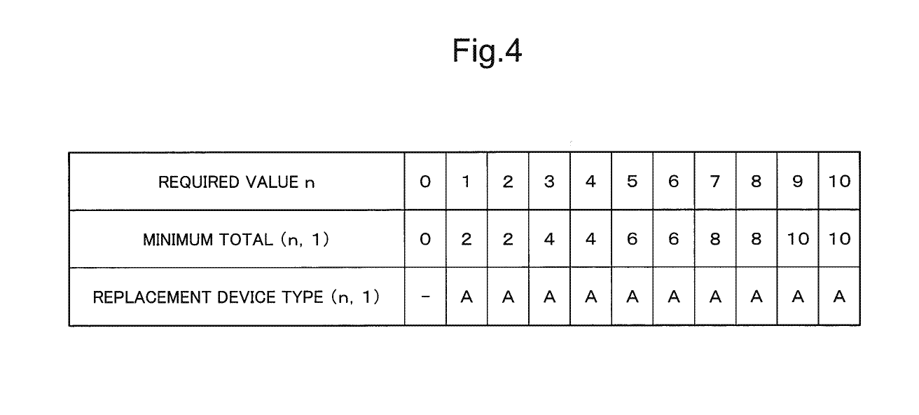

FIG. 4 is an example of the minimum totals (n, 1) and the replacement device types (n, 1) which the initialize unit 13 stored in the configuration storage unit 12. In an example of FIG. 4, N equals 10.

Each of the numerical values in the upper row in FIG. 4 is the required value n (where n is equal to or more than 0 and less than or equal to N) where the total value of the first index has to be equal to or more than this numerical value. The numerical values in the middle row in FIG. 4 are the minimum totals (n, 1). The numerical values in the lower row in FIG. 4 are the replacement device types (n, 1). For example, in FIG. 4, the column in which the value of the upper row equals 1 represents that the required value is 1, the minimum total (1, 1) is 2 and the replacement device type (1, 1) is A. This means that, for a set whose total value of the second indexes is minimum among sets which include only the first type of the devices (i.e. device type A) and whose total values of the first indexes are equal to or more than 1, the total value of the second indexes is 2, and the type of the last added device is the device type A.

Then, the configuration update unit 14, while increasing i from 2 to J and increasing n from 1 to N, as being described below, updates the minimum total and the replacement device type which the configuration storage unit 12 stores, based on the device information on the i-th type of the devices read out from the device storage unit 11 (Steps S13 to S15).

When i is smaller than J which is the number of types of the devices (Y in Step S13), the configuration update unit 14 performs the following processes. When i is smaller than J which is the number of types of the devices, it means that update of the minimum total and the replacement device type using the device information on all the types of the devices has not been completed, and there still exists a type of the devices to be read out to update the minimum total and the replacement device type.

First, the configuration update unit 14 increases i by 1. For example, i equals 1 just after completion of the process by the initialize unit 13, then the configuration update unit 14 increases i by 1 to 2. Then, the configuration update unit 14 reads out the device information on the i-th type of the devices from the device storage unit 11. For example, when i equals 2, the configuration update unit 14 reads out the device information on the second type of the devices (i.e. the first index P1(2) and the second index P2(2)) from the device storage unit 11 (Step S14).

Then, the configuration update unit 14 performs, while increasing n from 1 to N, the process of updating the minimum total (n, i) and the replacement device type (n, i) for each n from 1 to N, as the following descriptions (Step S15).

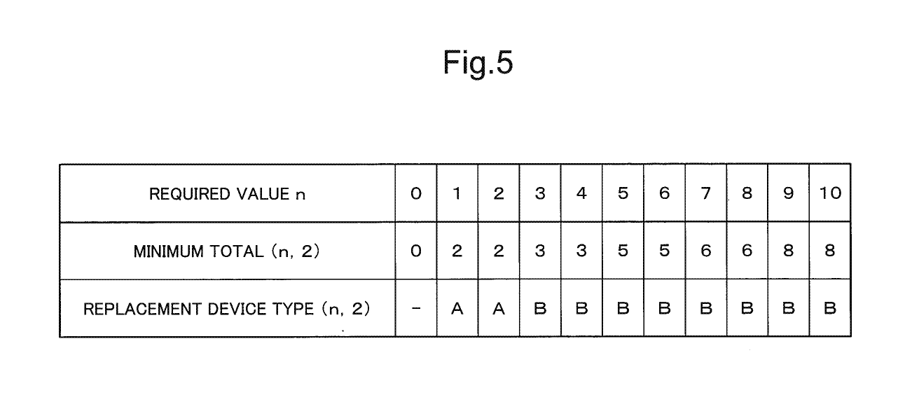

FIG. 5 is an example of the minimum totals (n, 2) and the replacement device types (n, 2), which the configuration update unit 14 stores in the configuration storage unit 12, in a case where i equals 2.

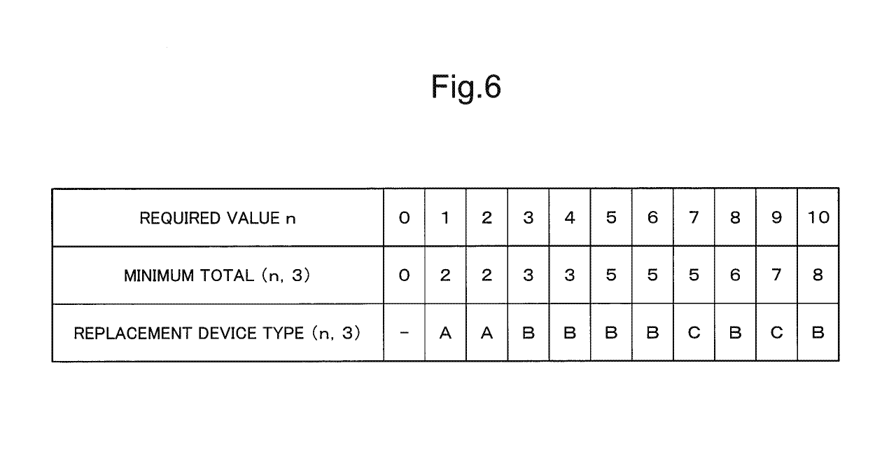

FIG. 6 is an example of the minimum totals (n, 3) and the replacement device types (n, 3), which the configuration update unit 14 stores in the configuration storage unit 12, in a case where i equals 3.

The configuration update unit 14 reads out the minimum total (n, i−1) and the minimum total (n−P1(i), i) from the configuration storage unit 12. The minimum total (n−P1(i), i) is the smallest total of the second indexes among totals of the second indexes of sets, each of which includes only devices of types whose number in numerical order is less than or equal to i and whose total of the first indexes is equal to or more than n if a device of the i-th type is added. Because the configuration update unit 14 processes them while increasing n from 1 to N, at this moment, the configuration update unit 14 has already derived the minimum total (n−P1(i), i) and has already stored in the configuration storage unit 12 as described below. Accordingly, the configuration storage unit 12 stores the minimum total (n−P1(i), i). In addition, as mentioned above, when n−P1(i) is smaller than 0, the minimum total (n−P1(i), i) equals 0.

Then, the configuration update unit 14 compares the minimum total (n, i−1), which is read out, with the summation of the minimum total (n−P1(i), i) and P2(i), which are similarly read out. As a result of the comparison, when the summation of the minimum total (n−P1(i), i) and P2(i) is the smaller, the configuration update unit 14 sets the summation of the minimum total (n−P1(i), i) and P2(i) as the minimum total (n, i), and sets the i-th type of the devices as the replacement device type (n, i). On the other hand, as a result of the above-mentioned comparison, when the minimum total (n, i−1) is not the larger, the configuration update unit 14 sets the minimum total (n, i−1) as the minimum total (n, i), and sets the replacement device type (n, i−1), which is read out from a configuration storage unit 122, as the replacement device type (n, i).

When updating of the minimum total (n, J) and the replacement device type (n, J) has been completed for each integer n from 1 to N (N in Step S13), the output unit 15 derives the minimum set (N, J) based on each replacement device type which the configuration storage unit 12 stores (Step S16).

In an example of figures from FIG. 3 to FIG. 6, the output unit 15 derives the minimum set (N, J) (where N=10 and J=3) as described as follows.

The replacement device type (10, 3) is B at the rightmost field in the lower row in FIG. 6. First, the output unit 15 adds B to the solution set. At this time the solution set becomes {B}. Referring to FIG. 3, the first index of the B equals 4. Then, the output unit 15 adds B, which is the replacement device type (10−4, 3), to the solution set. At this time, the solution set becomes {B, B}. Then, the output unit 15 adds A, which is the replacement device type (10−4−4, 3), to the solution set. At this time, the solution set becomes {B, B, A}. The first index of A equals 2. Because 10−4−4−2 equals 0, this solution set is the minimum set (10, 3).

The output unit 15 outputs the minimum total (N, J) and the minimum set (N, J) to such as the terminal 2 (Step S17).

The configuration management device 1 according to the exemplary embodiment brings an effect that it is possible to derive, from devices of plural types, each of which has two different indexes, a combination of the devices, which has, among combinations which satisfy a condition that the total of one indexes is equal to or more than a specified value, the smallest total of the other indexes.

This is because the configuration update unit 14 sequentially repeats processes in which, when a total of the second indexes of a new set made by replacing at least a part of the minimum set (n, i−1) with a device of the i-th type is smaller than the minimum total (n, i−1), the above-mentioned new set is set to the minimum set (n, i) and the i-th type of the devices is set to the replacement device type (n, i). By repeating the above-mentioned processes, the configuration update unit 14 derives the minimum total (N, J) and the replacement device type (N, J), and the minimum set (N, J) is derived based on each derived replacement device type (n, i).

The configuration management device 1 according to the exemplary embodiment brings the second effect that it is possible to derive the above-mentioned combination of the devices with a small amount of calculations.

The reason is because, without calculating, for all the combinations of the devices, whose totals of one indexes are equal to or more than a specified value, a total of the other indexes, the configuration update unit 14 can derives a combination of the devices, which has the smallest total of the other indexes.

### Second Exemplary Embodiment

Then, the second exemplary embodiment of the present invention is described in detail with reference to the drawings.

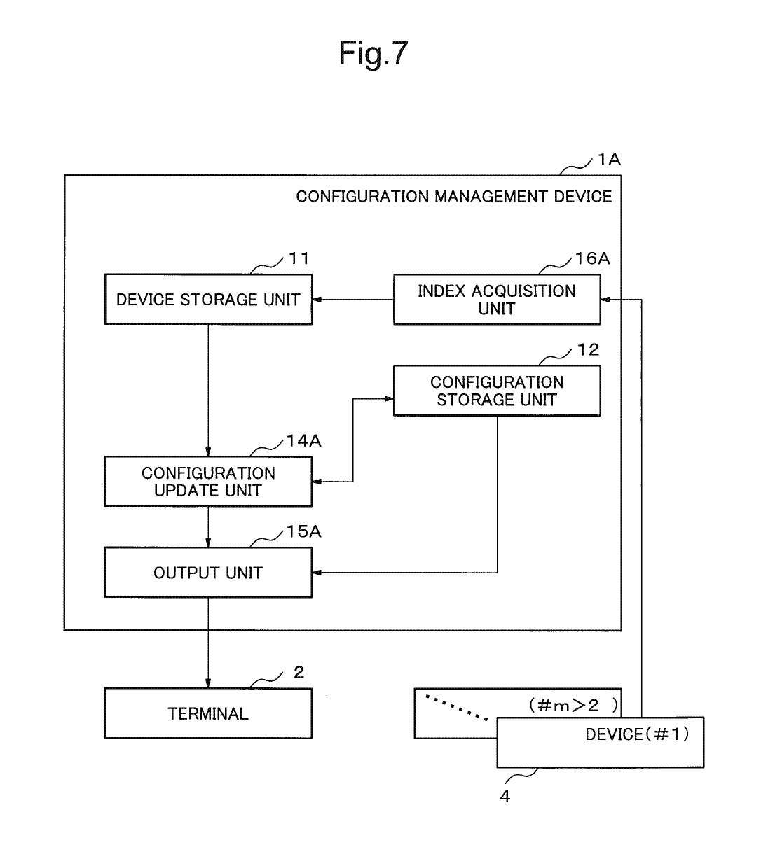

FIG. 7 is the block diagram showing the configuration management device 1A according to the second exemplary embodiment of the present invention.

Referring to FIG. 7, the configuration management device 1A includes the device storage unit 11, the configuration storage unit 12, a configuration update unit 14A, an output unit 15A and an index acquisition unit 16A. In addition, the terminal 2 and a device 4 are connected with the configuration management device 1A. Further, there exist plural devices 4. In addition, it is also preferable that the device 4 is one or more pieces of apparatus which hold the device information on a plurality of devices which are under their management.

Comparing with the configuration of the configuration management device 1 according to the first exemplary embodiment described in FIG. 1, differences are on a point that the configuration management device 1A according to the exemplary embodiment does not include the initialize unit 13, the configuration update unit 14, the output unit 15 nor the index acquisition unit 16, but includes the configuration update unit 14A, the output unit 15A and the index acquisition unit 16A. Hereinafter, differences between the second exemplary embodiment and the first exemplary embodiment are mainly described.

The device storage unit 11 stores two indexes and the number for each of a plurality of types of the devices which have at least two different indexes. Descriptions of the two indexes are omitted because these two indexes are the same as the two indexes in the first exemplary embodiment. The number of devices is the largest number of the devices which can be included in a set of devices for each type.

The first index, the second index and number of devices of each device, which the device storage unit 11 stores, can be given in advance, or can be obtained by the index acquisition unit 16A, which is described below.

Because the configuration storage unit 12 is the same as the configuration storage unit 12 according to the first exemplary embodiment, the descriptions of the configuration storage unit 12 is omitted. However, according to the exemplary embodiment, all the minimum totals (n, i) which the configuration storage unit 12 stores equals 0 and all the replacement device types (n, i) are the invalid values at an initial state before the configuration update unit 14A initiates processes.

The configuration update unit 14A performs the following processes while increasing j from 1 to J (where J is the number of the types of the devices).

First, the configuration update unit 14A reads out the first index P1(j), the second index P2(j) and the number of devices L(j), which are of the j-th type of the devices, from the device storage unit 11. According to the exemplary embodiment, the device information of the j-th type of the devices includes the first index P1(j), the second index P2(j) and the number of devices L(j).

Then, the configuration update unit 14A performs a process of updating the minimum totals and the replacement device types, described as follows, while increasing i from T(j−1)+1 to T(j). Here, T(j) is the number of devices of types whose number in numerical order is less than or equal to j. In addition, T(j) equals the summation of T(j−1) and L(j). Further, T(0) equals 0.

First, the configuration update unit 14A calculates a summation S which is a summation of the first indexes of all devices whose number in numerical order is less than or equal to i. It is preferable that the configuration update unit 14A calculates S, for example, by setting the initial value of S to 0 when it initiates the process, and adding the first index P1(j) of type j which is the type of the i-th device to S every time when i is increased. When S is equal to or more than N, the configuration update unit 14A may discontinue the update. Further, in the following descriptions, S or S(i) is a summation of the first indexes of all devices whose number in numerical order is less than or equal to the i. When a character other than i is denoted in a parenthesis like of S(a) for example, S(a) is a summation of the first indexes of all devices whose number in numerical order is less than or equal to the a.

Then, the configuration update unit 14A performs the following processes, while increasing n from 1 to N. If n is less than or equal to S, first, the configuration update unit 14A reads out the minimum total (n, i−1) and the replacement device type (n, i−1) from the configuration storage unit 12.

When the replacement device type (n, i−1) is an valid value, then the configuration update unit 14A compares the minimum total (n, i−1) with the summation of the minimum total (n−P1(j), i−1) and P2(j) (i.e. minimum total (n−P1(j), i−1)+P2(j)) which are read out from the configuration storage unit 12.

When the replacement device type (n, i−1) is a invalid value, or when the summation of the minimum total (n−P1(j), i−1) and P2(j) is smaller than the minimum total (n, i−1) as a result of the above-mentioned comparison, the configuration update unit 14A sets the summation of the minimum total (n−P1(j), i−1) and P2(j) as the minimum total (n, i), and sets the j-th type of the devices to the replacement device type (n, i).

Further, when the summation of the first indexes of devices whose number in numerical order is less than or equal to i is denoted as S(i), the minimum set (S(i), i) is a set including all devices whose number in numerical order is less than or equal to the i. In addition, the minimum total (S(i), i) is the summation of the second indexes of all devices whose number in numerical order is less than or equal to i. When the minimum set (n1, i) exists for a certain positive integer n1, the minimum set (n2, i) corresponding to a positive integer n2 which is smaller than n1 also exists. In addition, derivation of the minimum total (n, i−1) and the replacement device type (n, i−1) for each positive integer n which is less than or equal to N has been completed. In addition, because S(i) equals S(i−1)+P1(j), when n is less than or equal to S(i), n−P1(j) is less than or equal to S(i−1). As is described above, even when the replacement device type (n, i−1) does not have a value, the minimum total (n−P1(j), i−1) and the replacement device type (n−P1(j), i−1) have values.

When n is larger than S, or when the summation of the minimum total (n−P1(j), i−1) and P2(j) is not smaller than the minimum total (n, i−1) as the result of the above-mentioned comparison, the configuration update unit 14A sets the minimum total (n, i−1) as the minimum total (n, i) and sets the replacement device type (n, i−1) as the replacement device type (n, i).

Then, the configuration update unit 14A stores the minimum total (n, i) and the replacement device type (n, i) in the configuration storage unit 12.

Further, when n is larger than S, the minimum set (n, i−1) and the minimum set (n, i) do not exist. Accordingly, in this case, it is not necessary to update the minimum total (n, i) nor the replacement device type (n, i).

In the above mentioned processes, when the summation of the minimum total (N−P1(j), i−1) and P2(j) is smaller than the minimum total (N, i−1), the configuration update unit 14 sets a set made by adding the minimum set (N−P1(j), i−1) and one device of the i-th type to the minimum set (N, i). In this case, the minimum set (N, i) is a set made by replacing at least a part of the minimum set (N, i−1) with one device of the i-th type.

The output unit 15A derives the minimum set (N, T(J)) from each replacement device type which the configuration storage unit 12 stores, and outputs the minimum total (N, T(J)) which is read out from the configuration storage unit 12 and the derived minimum set (N, T(J)). A destination of output by the output unit 15A is such as the terminal 2.

The output unit 15A performs derivation of the minimum set (N, T(J)), for example, as follows.

First, the output unit 15A sets an empty set to a set (i.e. solution set) to be outputted as the minimum set (N, T(J)). Because the type of the device last added to the minimum set (N, T(J)) is the replacement device type (N, T(J)), the output unit 15 reads out the replacement device type (N, T(J)) from the configuration storage unit 12 and adds the replacement device type (N, T(J)) to the solution set. When the first index of the replacement device type (N, T(J)) is denoted as P1(X), a set made by excluding the replacement device type (N, T(J)) from the minimum set (N, T(J)) is the minimum set (N−P1 (X), T(J)−1).

Similarly, because the type of the device last added to the minimum set (n, i) is the replacement device type (n, i), the output unit 15A reads out the replacement device type (n, i) from the configuration storage unit 12 and adds the replacement device type (n, i) to the solution set. A set made by excluding the replacement device type (n, i) is excluded from the minimum set (n, i) is the minimum set (n−P1(x), i−1). Further, P1(x) is the first index of the replacement device type (n, i).

As described above, the processes in which the replacement device type (n, i), which is the type of the device last added to the minimum set (n, i), is excluded from the minimum set (n, i) and is added to the solution set, and the minimum set (n−P1(x), i−1), which is made by excluding the replacement device type (n, i) from the minimum set (n, i), is set to the next minimum set from which the last added device is excluded, until n becomes less than or equal to 0.

The minimum set (N, T(J)) is the solution set when n becomes less than or equal to 0.

The index acquisition unit 16A obtains two indexes or two indexes and the number of devices for each type of the devices from, for example, all connected devices 4, accumulates them, and stores the two indexes and the number for each type of the devices in the device storage unit 11. The device 4 is, for example, one of the devices having above-mentioned two indexes. In addition, the device 4 can be, for example, a apparatus which manages the devices which have the above-mentioned two indexes, and holds the two indexes and the number of devices for each type of the devices which have the above-mentioned two indexes and which are under their management.

It is also preferable that the index acquisition unit 16A obtains the two indexes or the two indexes and the number of devices for each type of the devices from, for example, all devices 4 which the user designated via an input unit or the like of the terminal 2 which is not illustrate, accumulates them, and stores the two index and the number of devices for each type of the devices in the device storage unit 11.

Next, operations according to the exemplary embodiment are described in detail with reference to the drawings.

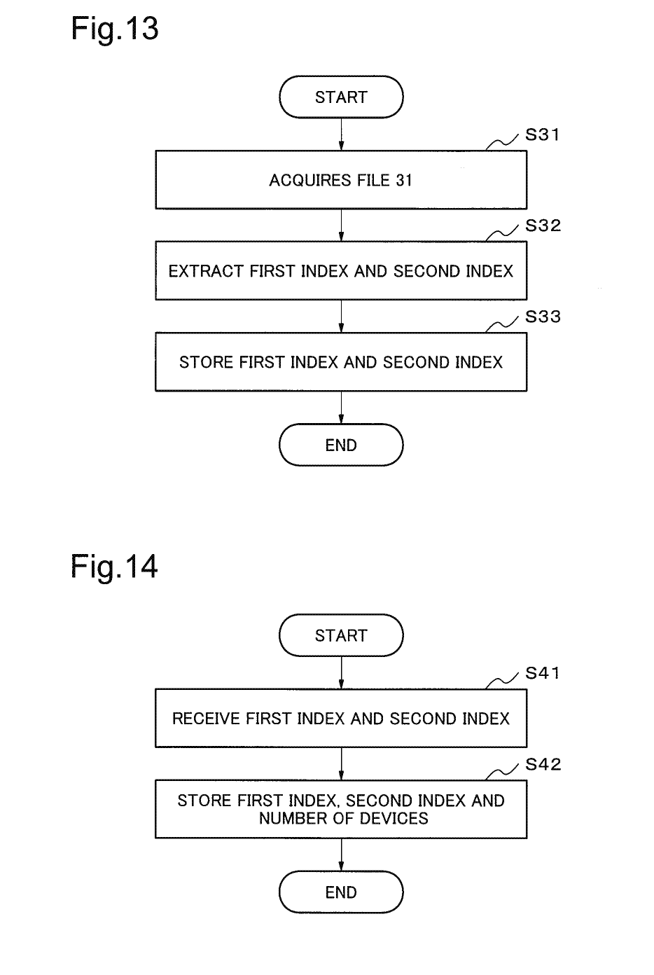

FIG. 14 is the flowchart showing an example of an operation in which the configuration management device 1A according to the exemplary embodiment obtains indexes of a device.

Referring to FIG. 14, first, the index acquisition unit 16A receives an instruction via an input unit or the like of the terminal 2 which is not illustrated, and receives the first indexes and the second indexes from all devices 4 designated by the instruction (Step S41).

Then, the index acquisition unit 16A the accumulated number of devices for each type and the first indexes and the second indexes for each type of the devices, which are extracted, and stores them in the device storage unit 11 associating with the type of the devices (Step S42).

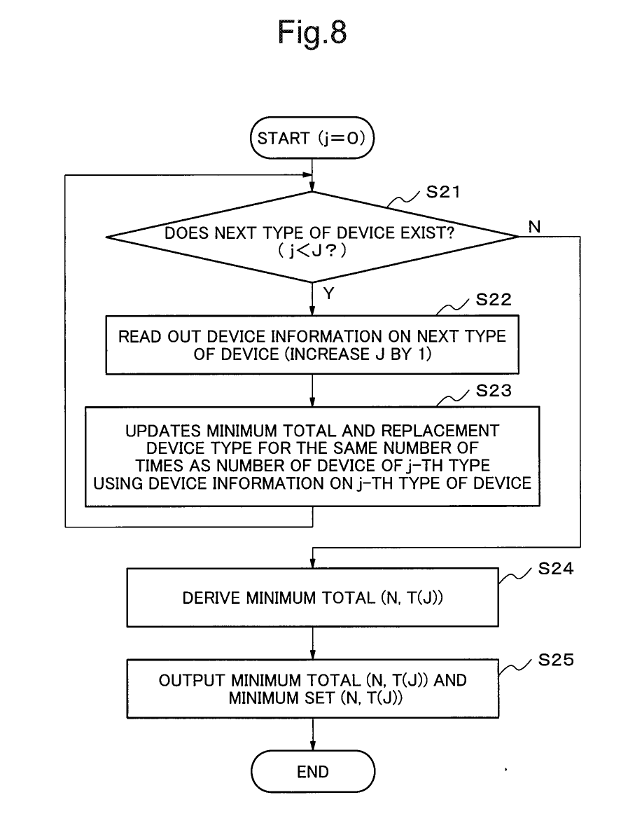

FIG. 8 is the flowchart showing an example of the operation in which the configuration management device 1A according to the exemplary embodiment derives the minimum set.

Referring to FIG. 8, the configuration update unit 14A, while increasing integer j from 1 to J (i.e. the number of the types of the devices) and increasing integer i from T(j−1)+1 to T(j) (where T(j) is the number of devices which have types whose number in numerical order is less than or equal to j), updates the minimum total and the replacement device type by the device information on the j-th type of the devices (Steps S21 to S23). Further, updating of the minimum total and the replacement device type means, as described below, that the configuration update unit 14A derives the minimum total (n, i) and the replacement device type (n, i), and stores the derived minimum total (n, i) and the derived replacement device type (n, i) in the configuration storage unit 12 associating with n and i respectively.

First, the configuration update unit 14A confirms whether there exists a device of a type for which the minimum total and the replacement device type are to be updated next, that is, updating of the minimum total and the replacement device type is not finished for all types of the devices (Step S21). When j, which is the number in numerical order for the type of the devices, on the last updating is equal to the integer J (N in Step S21), updating of the minimum total and the replacement device type using the information on all types of the devices has finished, and there is not the next type of the devices for which the minimum total and the replacement device type are to be updated.

When j, which is the number numerical order for the type of the devices, on the last updating is smaller than the integer J (Y in Step S21), the configuration update unit 14A increases j by 1, and reads out the device information on the j-th type of the devices from the device storage unit 11 (Step S22). The device information according to the exemplary embodiment includes the first index, the second index and the number of devices for each type. Further, according to the example of the operation, the configuration update unit 14A sets j to 0 at the start of the operation, and increases j by 1 before reading out the device information. In addition, the configuration update unit 14A can have a configuration in which j is set to 1 at the start of the operation, and j is increased by 1 at a time when updating for all the devices of the j-th type has been completed.

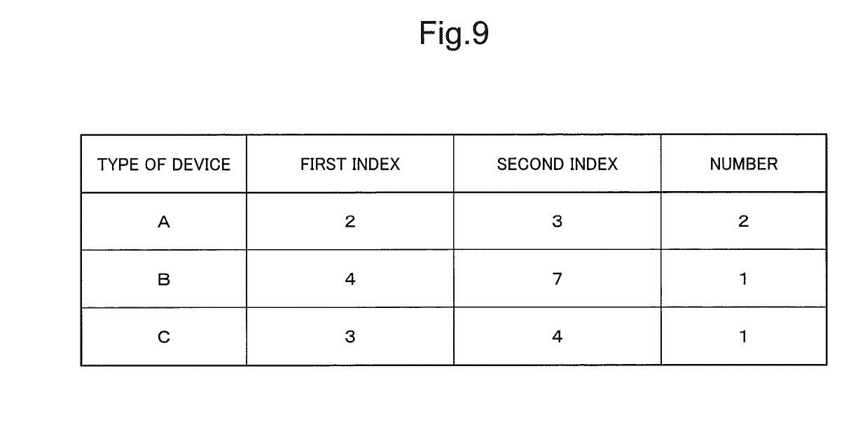

FIG. 9 is an example of the device information which the device storage unit 11 stores. In an example in FIG. 9, J which is the number of types of devices is equal to 3. When the number in numerical order of each type of the devices is assigned sequentially from the top in FIG. 9, the first type of the devices is A, the second type of the devices is B and the third type of the devices is C. In addition, in the examples in the figures from FIG. 10 to FIG. 12, which are described below, the required value N equals 9.

Then, the configuration update unit 14A updates the minimum total and the replacement device type, using the first index and the second index of the j-th type of the devices for the same number of times as the number of devices of the j-th type, L(j), which is read out (Step S23). In Step S23, first, the configuration update unit 14A set the summation T(j−1)+1, which is the number of devices of types whose number in numerical order is less than or equal to j, as i. While increasing i to T(j) (where T(j) equals T(j−1)+L(j)) and n from 1 to smaller one of S(i) and N one by one respectively, using the first index and the second index of the j-th type of the devices, the configuration update unit 14A derives the minimum total (n, i) and the replacement device type (n, i) as described above. The configuration update unit 14A stores the derived minimum total (n, i) and the derived replacement device type (n, i) in the configuration storage unit 12, associating with n and i.

FIG. 10 is an example of the minimum totals (n, 2) and the replacement device types (n, 2), which the configuration update unit 14A derived based on the device information of FIG. 9, in a case where j equals 1. As shown in FIG. 9, because number of devices (L (1)) of the device type A is 2, T(1) is also 2.

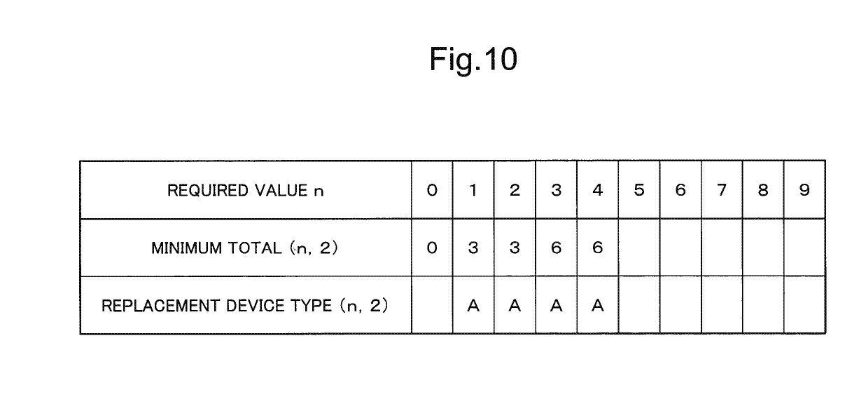

FIG. 11 is an example of the minimum totals (n, 3) and the replacement device types (n, 3), which the configuration update unit 14A derived, in a case where j equals 2.

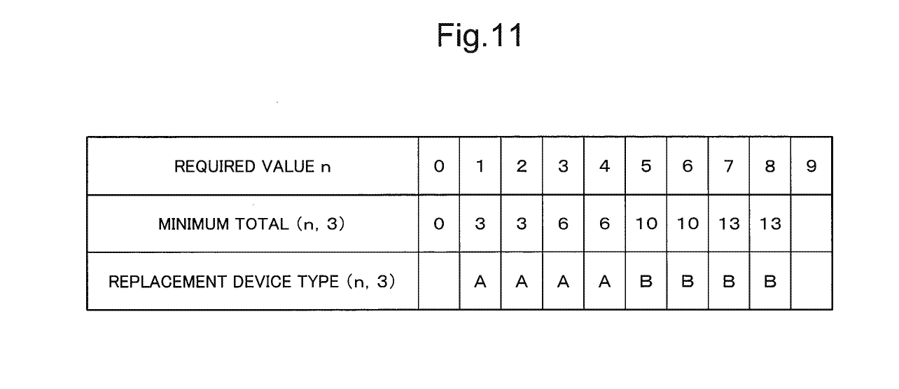

FIG. 12 is an example of the minimum totals (n, 4) and the replacement device types (n, 4), which the configuration update unit 14A derived, in a case where j equals 3. In the example of FIG. 12, when n equals 3, the configuration update unit 14A compares the minimum total (3, 3) with the minimum total (3−P1(3), 3)+P2(3). Because the minimum total (3, 3) equals 6 and the minimum total (3−3, 3)+P2(3) equals 0+4, and therefore the minimum total (3−3, 3)+P2(3) is smaller, the configuration update unit 14A sets the value of the minimum total (3−3, 3)+P2(3), which equals 4, as the minimum total (3,4), and sets C, which is the third type of the devices, as the replacement device type. Similarly, when n equals 5, the configuration update unit 14A compares the minimum total (5, 3) with the minimum total (5−P1(3), 3)+P2(3). Because the minimum total (5, 3) equals 10 and the minimum total (5−3, 3)+P2(3) equals 3+4, and therefore the minimum total (5−3, 3)+P2(3) is smaller, the configuration update unit 14A sets the value of the minimum total (5−3, 3)+P2(3), which equals 7, as the minimum total (5, 4), and sets C, which is the third type of the devices, as the replacement device type. Further, when n equals 7, the configuration update unit 14A compares the minimum total (7, 3) with the minimum total (7−P1(3), 3)+P2(3). Because the minimum total (7, 3) equals 13 and the minimum total (7−3, 3)+P2(3) equals 6+4, and therefore the minimum total (7−4, 3)+P2(3) is the smaller, the configuration update unit 14A sets the value of the minimum total (7−3, 3)+P2(3), which is equals 10, as the minimum total (7, 4), and sets C, which is the third type of the device, as the replacement device type.

When j equals J, i equals T(J) and n equals N, the minimum total (N, T(J)) and the replacement device type (N, T(J)) is derived. In the example of the device in FIG. 9, because J equals 3, T(J) equals 4 and N equals 9, the minimum total (N, T(J)) is 14 which is the value at the rightmost field in the middle row in FIG. 12, and the replacement device type (N, T(J)) is C which is the value at the rightmost field in the lower row.

When j, which is the number in numerical order of the type of the devices, on the last updating is equivalent with integer J (N in Step S21), the output unit 15A derives the minimum set (N, T(j) (Step S24), as described above.

The output unit 15A outputs the minimum total (N, T(J)) and the minimum set (N, T(j)) (Step S25).

The configuration management device 1A according to the exemplary embodiment brings an effect that it is possible to derive a combination of a plurality of types of the devices having two different indexes, which satisfies a condition that the total of one indexes is equal to or more than a specified value and whose total of the other indexes is minimum, when the number of devices for each type of the devices has a limitation.

This is because the configuration update unit 14A sequentially repeats processes in which, when total of the second index of a new set which is made by replacing at least a part of the minimum set (n, i−1) with a device of the i-th type is smaller than the minimum total (n, i−1), the above-mentioned new set is set as the minimum set (n, i) and the i-th type of a devices is set as the replacement device type (n, i) By repeating the above-mentioned processes, the configuration update unit 14A derives the minimum total (N, T(J)) and the replacement device type (N, T(J)), and derives the minimum set (N, T(J)) based on each derived replacement device type (n, i).

The configuration management device 1A according to the exemplary embodiment brings the second effect that it is possible to derive a combination of the above-mentioned devices with a little amount of calculations.

The reason is because the configuration update unit 14A can derives a combination of devices whose total of the other indexes is minimum without calculating totals of the other indexes for all the combinations of devices whose totals of one indexes is equal to or more than the specified value.

### Third Exemplary Embodiment

Then, the configuration management device according to the third exemplary embodiment of the present invention is described in detail with reference to a drawing. The exemplary embodiment is a minimum configuration of the present invention.

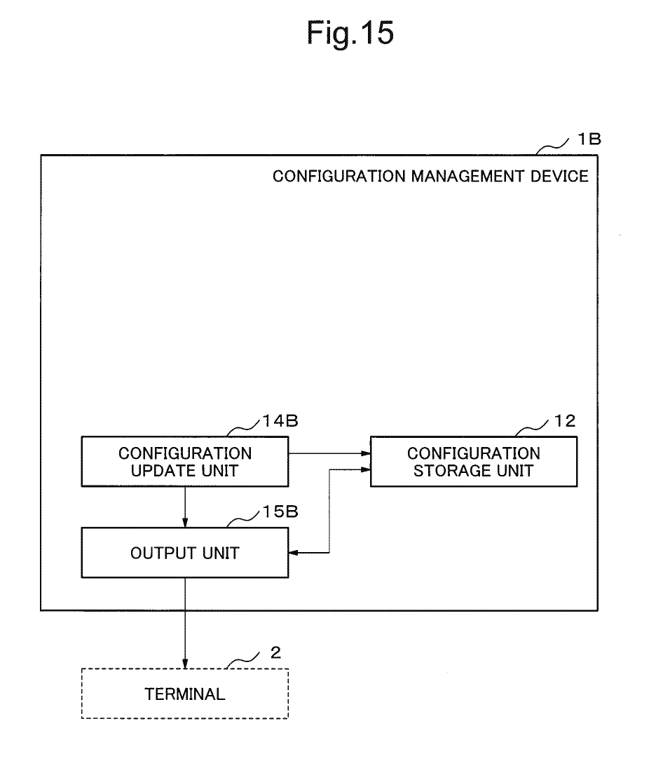

Referring to FIG. 15, a configuration management device 15A, where a set is composed of i types of devices, each of the devices is associated with a P1 which is a value of a first index and a P2 which is a value of a second index for each of the types, and the set whose total of the P2s is smallest among the sets whose totals of the P1s are equal to or more than n is denoted as a minimum set (n, i), and a total of the P2s of the devices which belong to the minimum set (n, i) is denoted as a minimum total (n, i), comprises: a device storage unit 12 which stores the P1 and the P2 for each of a plurality (J) of types of the devices; a configuration update unit 14B which inputs a required value N and acquiring a minimum set (N, i) while increasing i to J, where, a) if a total of the P2s of a new set which is acquired by replacing at least a part of a minimum set (N, i−1) with a device of i-th type, the minimum set (N, i) is the new set, and b) if the total of the P2s of each new set is not smaller than the minimum total (N, i−1), the minimum set (N, i) is the minimum set (N, i−1); and an output unit 15B which outputs a minimum set (N, J).

Then, an effect of the invention is described.

The configuration management device 1B according to the exemplary embodiment brings an effect that it is possible to derive a combination of a plurality of types of the devices having two different indexes, which satisfies a condition that the total of one indexes is equal to or more than a specified value and whose total of the other indexes is minimum, when number of devices for each type of the devices has a limitation.

This is because the configuration update unit 14B sequentially repeats processes in which, when the total of the second indexes of a new set, which is made by replacing at least a part of the minimum set (N, i−1) with a device of the i-th type, is smaller than the minimum total (N, i−1), the above-mentioned new set is set as the minimum set (N, i) and the i-th type of the devices is set as the replacement device type (N, i). By repeating the above-mentioned processes, the configuration update unit 14B derives the minimum total (N, J) and the replacement device type (N, J), and derives the minimum set (N, J) based on derived each replacement device type (n, i).

While having described an invention of the present application referring to the embodiments, the invention of the present application is not limited to the above mentioned embodiments. It is to be understood that to the configurations and details of the invention of the present application, various changes can be made within the scope of the invention of the present application by those skilled in the arts.

This application is based upon and claims the benefit of priority from Japanese patent application No. 2010-213410, filed on Sep. 24, 2010, the disclosure of which is incorporated herein in its entirety by reference.

### INDUSTRIAL AVAILABILITY TO USE

The present invention is suitable for apparatuses or systems which suppress system production cost, in the case of system configuration.

### DESCRIPTION OF THE CODES

1, 1A and 1B Configuration Management Device
2 Terminal
3 Server
4 Device
11 Device Storage Unit
12 Configuration Storage Unit
13 Initialize Unit
14, 14A and 14B Configuration Update Unit
15, 15A and 15B Output Unit
16 and 16A Index Acquisition Unit
31 File

1. A configuration management device, where a set is composed of i types of devices, each of the devices is associated with a P1 which is a value of a first index and a P2 which is a value of a second index for each of the types, and the set whose total of the P2s is smallest among the sets whose totals of the P1s are equal to or more than n is denoted as a minimum set (n, i), and a total of the P2s of the devices which belong to the minimum set (n, i) is denoted as a minimum total (n, i), comprising:
a device storage unit which stores the P1 and the P2 for each of a plurality (J) of types of the devices;
a configuration update unit which updates a required value N and acquiring a minimum set (N, i) while increasing i to J, where, a) if a total of the P2s of a new set which is acquired by replacing at least a part of a minimum set (N, i−1) with a device of i-th type, the minimum set (N, i) is the new set, and b) if the total of the P2s of each new set is not smaller than the minimum total (N, i−1), the minimum set (N, i) is the minimum set (N, i−1); and
an output unit which outputs a minimum set (N, J).

2. The configuration management device according to claim 1, wherein
the P1 is a performance index value of the device and the P2 is a cost index value of the device.

3. The configuration management device according to claim 1, where the P1 of the device of the i-th type is denoted as the P1(i) and the P2 of the device of the i-th type is denoted as the P2(i), comprising:
a configuration storage unit which stores the minimum total (n, i), where n is an integer equal to or more than 0 and less than or equal to N and i is an integer equal to or more than 1 and less than or equal to J, and a replacement device type (n, i) representing the type of the device last added to the minimum set (n, i) associating with n and i; and
an initialize unit which acquires a minimum total (n, 1) based on the P1(1) and the P2(1) for each of n, where n is a nonnegative integer less than or equal to the input value N, and stores the minimum total (n, 1) and the first type of the devices as the replacement device type (n, 1) in the configuration storage unit; wherein
the configuration update unit stores, while sequentially increasing i from 2 to J and sequentially increasing n from 1 to N respectively, a) the minimum total (n−P1(i), i)+P2(i) as a minimum total (n, i) and the i-th type of the devices as a replacement device type (n, i) if the minimum total (n−P1(i), i)+P2(i) is smaller than the minimum total (n, i−1), and b) the minimum total (n, i−1) as the minimum total (n, i) and the replacement device type (n, i−1) as the replacement device type (n, i) if the minimum total (n−P1(i), i)+P2(i) is not smaller than the minimum total (n, i−1), in the configuration storage unit, and
the output unit acquires the minimum set (N, J) based on the replacement device type (m, J), where m is equal to or more than 1 and less than or equal N, and outputs the minimum set (N, J).

4. The configuration management device according to claim 3, comprising:
an index acquisition unit which inputs the P1s and the P2s corresponding to model names of the J types of the devices from a file which stores the P1s and the P2s corresponding to the model names, and stores the inputted the P1s and the P2s in the device storage unit.

5. The configuration management device according to claim 1, where the minimum total (n, i) equals 0 and the replacement device type (n, i) does not have an effective value when i is 0 or n is less than or equal to 0, in addition, a value of the first index and the second index of the j-th type of the devices are denoted as the P1(j) and the P2(j) respectively, number of devices for each type is denoted as L, number of devices of the j-th type is denoted as L(j) and total number of devices each of which is of a type whose numerical order is less than or equal to j is denoted as T(j), comprising:
a configuration storage unit which stores the minimum set (n, i), where n is a nonnegative integer less than or equal to the input value N and i is a positive integer less than or equal to T(j), and the replacement device type (n, i) representing a type of a device last added to the minimum total (n, i), wherein
the device storage unit stores values of L, the P1 and the P2 for each type of devices among a plurality (J) of types of devices,
the configuration update unit stores the minimum total (n, i) and the replacement device type (n, i) associated with n and i in the configuration storage unit, if n is less than or equal to S which is a summation of the first index of all devices each of which is of a type whose numerical order is less than or equal to the i, while sequentially increasing j from 1 to the J, sequentially increasing i from T(j−1)+1 to T(j)=T(j−1)+L(j) and sequentially increasing n from 1 to the N, where a) the minimum total (n, i) is the minimum total (n−P1(j), i−1)+P2(j) and the replacement device type (n, i) is j, if the replacement device type (n, i−1) does not have the effective value or the minimum total (n−P1(j), i−1)+P2(j) is smaller than the minimum total (n, i−1), or b) the minimum total (n, i) is the minimum total (n, i−1) and the replacement device type (n, i) is the replacement device type (n, i−1), if the minimum total (n−P1(j), i−1)+P2(j) is not smaller than the minimum total (n, i−1), and
the output unit acquires a minimum set (N, T(J)) based on the replacement device type (m, T(J)), where m is equal to or more than 1 and less than or equal to N, and outputs the minimum set (N, T(J)).

6. The configuration management device according to claim 5, comprising:
an index acquisition unit which inputs a model name, the P1 and the P2, from a plurality of devices which are connected with the configuration management device via a network and store the model name, the P1 and the P2, and stores the model name, the P1 and the P2 in the device storage unit.

7. A configuration management device, comprising:
the plurality of devices; and
the configuration management system according to claim 6.

8. A configuration management method, where a set is composed of i types of devices, each of the devices is associated with a P1 which is a value of a first index and a P2 which is a value of a second index for each of the types, and the set whose total of the P2s is smallest among the sets whose totals of the P1s are equal to or more than n is denoted as a minimum set (n, i), and a total of the P2s of the devices which belong to the minimum set (n, i) is denoted as a minimum total (n, i), comprising:
storing the P1 and the P2 for each of a plurality (J) of types of the devices in a device storage unit;
inputting a required value N and acquiring a minimum set (N, i) while increasing i to J, where, a) if a total of the P2s of a new set which is acquired by replacing at least a part of a minimum set (N, i−1) with a device of i-th type, the minimum set (N, i) is the new set, and b) if the total of the P2s of each new set is not smaller than the minimum total (N, i−1), the minimum set (N, i) is the minimum set (N, i−1); and
outputting a minimum set (N, J).

9. The configuration management method according to claim 8, wherein the P1 is a performance index value of the device and the P2 is a cost index value of the device.

10. The configuration management method according to claim 8, where the P1 of the device of the i-th type is denoted as the P1(i) and the P2 of the device of the i-th type is denoted as the P2(i), comprising:
storing the minimum total (n, i), where n is an integer equal to or more than 0 and less than or equal to N and i is an integer equal to or more than 1 and less than or equal to J, and a replacement device type (n, i) representing the type of the device last added to the minimum set (n, i) associating with n and i in a configuration storage unit; and
acquiring a minimum total (n, 1) based on the P1(1) and the P2(1) for each of n, where n is a nonnegative integer less than or equal to the input value N, and storing the minimum total (n, 1) and the first type of the devices as the replacement device type (n, 1) in the configuration storage unit; wherein
storing, while sequentially increasing i from 2 to J and sequentially increasing n from 1 to N respectively, a) the minimum total (n−P1(i), i)+P2(i) as a minimum total (n, i) and the i-th type of the devices as a replacement device type (n, i) if the minimum total (n−P1(i), i)+P2(i) is smaller than the minimum total (n, i−1), and b) the minimum total (n, i−1) as the minimum total (n, i) and the replacement device type (n, i−1) as the replacement device type (n, i) if the minimum total (n−P1(i), i)+P2(i) is not smaller than the minimum total (n, i−1), in the configuration storage unit, and
acquiring the minimum set (N, J) based on the replacement device type (m, J), where m is equal to or more than 1 and less than or equal to N, and outputting the minimum set (N, J).

11. The configuration management method according to claim 10, comprising:
inputting the P1s and the P2s corresponding to model names of the J types of the devices from a file which stores the P1s and the P2s corresponding to the model names, and storing the inputted P1s and the inputted P2s in the device storage unit.

12. The configuration management method according to claim 8, where the minimum total (n, i) equals 0 and the replacement device type (n, i) does not have an effective value when i is 0 or n is less than or equal to 0, in addition, a value of the first index and the second index of the j-th type of the devices are denoted as the P1(j) and the P2(j) respectively, number of devices for each type is denoted as L, number of devices of the j-th type is denoted as L(j) and total number of devices each of which is of a type whose numerical order is less than or equal to j is denoted as T(j), comprising:
storing the minimum set (n, i), where n is a nonnegative integer less than or equal to the input value N and i is a positive integer less than or equal to T(j), and the replacement device type (n, i) representing a type of a device last added to the minimum total (n, i) in a configuration storage unit;
storing values of L, the P1 and the P2 for each type of devices among a plurality (J) of types of devices;
storing the minimum total (n, i) and the replacement device type (n, i) associated with n and i in the configuration storage unit, if n is less than or equal to S which is a summation of the first index of all devices each of which is of a type whose numerical order is less than or equal to the i, while sequentially increasing j from 1 to the J, sequentially increasing i from T(j−1)+1 to T(j)=T(j−1)+L(j) and sequentially increasing n from 1 to the N, where a) the minimum total (n, i) is the minimum total (n−P1(j), i−1)+P2(j) and the replacement device type (n, i) is j, if the replacement device type (n, i−1) does not have the effective value or the minimum total (n−P1(j), i−1)+P2(j) is smaller than the minimum total (n, i−1), or b) the minimum total (n, i) is the minimum total (n, i−1) and the replacement device type (n, i) is the replacement device type (n, i−1), if the minimum total (n−P1(j), i−1)+P2(j) is not smaller than the minimum total (n, i−1), and
acquiring a minimum set (N, T(J)) based on the replacement device type (m, T(J)), where m is equal to or more than 1 and less than or equal to N, and outputting the minimum set (N, T(J)).

13. The configuration management method according to claim 12, comprising:
inputting a model name, the P1 and the P2, from a plurality of devices which are connected with the configuration management device via a network and store the model name, the P1 and the P2, and storing the model name, the P1 and the P2 in the device storage unit.

14. A non-transitory computer-readable medium storing a configuration management program which makes a computer execute, where a set is composed of i types of devices, each of the devices is associated with a P1 which is a value of a first index and a P2 which is a value of a second index for each of the types, and the set whose total of the P2s is smallest among the sets whose totals of the P1s are equal to or more than n is denoted as a minimum set (n, i), and a total of the P2s of the devices which belong to the minimum set (n, i) is denoted as a minimum total (n, i), as:
a device storage unit which stores the P1 and the P2 for each of a plurality (J) of types of the devices;
a configuration update unit which stores a required value N and acquiring a minimum set (N, i) while increasing i to J, where, a) if a total of the P2s of a new set which is acquired by replacing at least a part of a minimum set (N, i−1) with a device of i-th type, the minimum set (N, i) is the new set, and b) if the total of the P2s of each new set is not smaller than the minimum total (N, i−1), the minimum set (N, i) is the minimum set (N, i−1); and
an output unit which updates a minimum set (N, J).

15. The non-transitory computer-readable medium storing a configuration management program according to claim 14 which makes a computer execute, wherein
the P1 is a performance index value of the device and the P2 is a cost index value of the device.

16. The non-transitory computer-readable medium storing a configuration management program according to claim 14 which makes a computer execute, where the P1 of the device of the i-th type is denoted as the P1(i) and the P2 of the device of the i-th type is denoted as the P2(i), as:
a configuration storage unit which stores the minimum total (n, i), where n is an integer equal to or more than 0 and less than or equal to N and i is an integer equal to or more than 1 and less than or equal to J, and a replacement device type (n, i) representing the type of the device last added to the minimum set (n, i) associating with n and i;
an initialize unit which acquires a minimum total (n, 1) based on the P1(1) and the P2(1) for each of n, where n is a nonnegative integer less than or equal to the input value N, and storing the minimum total (n, 1) and the first type of the devices as the replacement device type (n, 1) in the configuration storage means; wherein
the configuration update unit stores, while sequentially increasing i from 2 to J and sequentially increasing n from 1 to N respectively, a) the minimum total (n−P1(i), i)+P2(i) as a minimum total (n, i) and the i-th type of the devices as a replacement device type (n, i) if the minimum total (n−P1(i), i)+P2(i) is smaller than the minimum total (n, i−1), and b) the minimum total (n, i−1) as the minimum total (n, i) and the replacement device type (n, i−1) as the replacement device type (n, i) if the minimum total (n−P1(i), i)+P2(i) is not smaller than the minimum total (n, i−1), in the configuration storage unit; and
the output unit which acquires the minimum set (N, J) based on the replacement device type (m, J), where m is equal to or more than 1 and less than or equal to N, and outputs the minimum set (N, J).

17. The non-transitory computer-readable medium storing a configuration management program according to claim 16 which makes a computer execute as:
an index acquisition unit which inputs the P1s and the P2s corresponding to model names of the J types of the devices from a file which stores the P1s and the P2s corresponding to the model names, and stores the inputted P1s and the inputted P2s in the device storage unit.

18. The non-transitory computer-readable medium storing a configuration management device according to claim 14 which makes a computer execute, where the minimum total (n, i) equals 0 and the replacement device type (n, i) does not have an effective value when i is 0 or n is less than or equal to 0, in addition, a value of the first index and the second index of the j-th type of the devices are denoted as the P1(j) and the P2(j) respectively, number of devices for each type is denoted as L, number of devices of the j-th type is denoted as L(j) and total number of devices each of which is of a type whose numerical order is less than or equal to j is denoted as T(j), as:
a configuration storage unit which stores the minimum set (n, i), where n is a nonnegative integer less than or equal to the input value N and i is a positive integer less than or equal to T(j), and the replacement device type (n, i) representing a type of a device last added to the minimum total (n, i);
the device storage unit which stores values of L, the P1 and the P2 for each type of devices among a plurality (J) of types of devices;
the configuration update unit which stores the minimum total (n, i) and the replacement device type (n, i) associated with n and i in the configuration storage unit, if n is less than or equal to S which is a summation of the first index of all devices each of which is of a type whose numerical order is less than or equal to the i, while sequentially increasing j from 1 to the J, sequentially increasing i from T(j−1)+1 to T(j)=T(j−1)+L(j) and sequentially increasing n from 1 to the N, where a) the minimum total (n, i) is the minimum total (n−P1(j), i−1)+P2(j) and the replacement device type (n, i) is j, if the replacement device type (n, i−1) does not have the effective value or the minimum total (n−P1(j), i−1)+P2(j) is smaller than the minimum total (n, i−1), or, b) the minimum total (n, i) is the minimum total (n, i−1) and the replacement device type (n, i) is the replacement device type (n, i−1), if the minimum total (n−P1(j), i−1)+P2(j) is not smaller than the minimum total (n, i−1); and
the output unit which acquires a minimum set (N, T(J)) based on the replacement device type (m, T(J)), where m is equal to or more than 1 and less than or equal to N, and outputs the minimum set (N, T(J)).

19. The non-transitory computer-readable medium storing a configuration management program according to claim 18 which makes a computer execute as:
an index acquisition unit which inputs a model name, the P1 and the P2, from a plurality of devices which are connected with the configuration management device via a network and store the model name, the P1 and the P2, and stores the model name, the P1 and the P2 in the device storage unit.

20. A configuration management device, where a set is composed of i types of devices, each of the devices is associated with a P1 which is a value of a first index and a P2 which is a value of a second index for each of the types, and the set whose total of the P2s is smallest among the sets whose totals of the P1s are equal to or more than n is denoted as a minimum set (n, i), and a total of the P2s of the devices which belong to the minimum set (n, i) is denoted as a minimum total (n, i), comprising:
a device storage means for storing the P1 and the P2 for each of a plurality (J) of types of the devices;
a configuration update means for inputting a required value N and acquiring a minimum set (N, i) while increasing i to J, where, a) if a total of the P2s of a new set which is acquired by replacing at least a part of a minimum set (N, i−1) with a device of i-th type, the minimum set (N, i) is the new set, and b) if the total of the P2s of each new set is not smaller than the minimum total (N, i−1), the minimum set (N, i) is the minimum set (N, i−1); and
an output means for outputting a minimum set (N, J).
